(19) United States
(12) Patent Application Publication
(10) Pub. No.: US 2021/0097559 A1
(43) Pub. Date: Apr. 1, 2021

(54) RIDER PICKUP LOCATION OPTIMIZATION SYSTEM

(71) Applicant: Uber Technologies,Inc., San Francisco, CA (US)

(72) Inventors: Michael Charles Albada, San Francisco, CA (US); Saebra Lynn Waterstraut, San Francisco, CA (US)

(21) Appl. No.: 16/948,744

(22) Filed: Sep. 30, 2020

Related U.S. Application Data
(60) Provisional application No. 62/908,547, filed on Sep. 30, 2019.

(51) Int. Cl. G06Q 30/02; G06Q 50/30; G06N 5/04

(52) U.S. Cl. CPC G06Q 30/0205; G06N 5/04; G06Q 50/30

(57) ABSTRACT

Systems and methods for optimizing a pickup location are provided. A network system receives a request for transportation service from a device of a rider, whereby the request includes a requested pickup location. Based on the requested pickup location, the network system determines one or more candidate pickup locations that optimize for the pickup location. The determining the one or more candidate pickup locations includes determining an actual location of the rider, accessing index scores associated with the actual location, identifying dwell point and hotspot candidates based on corresponding index scores, and selecting one or more dwell point and hotspot candidates as the one or more candidate pickup locations. The network system then causes presentation of the one or more candidate pickup locations on a user interface on the device of the rider.

### REFERENCE TO RELATED APPLICATIONS

This application claims the priority benefit of U.S. Provisional Patent Application No. 62/908,547 filed Sep. 30, 2019 and entitled “Rider Pickup Location Optimization System,” which is incorporated herein by reference in its entirety.

### TECHNICAL FIELD

The subject matter disclosed herein generally relates to special-purpose machines configured for optimizing a pickup location, and to the technologies by which such special-purpose machines become improved compared to other machines that determine pickup locations. Specifically, the present disclosure addresses systems and methods that optimize a pickup location for convenience of both a rider and driver based on historical data.

### BACKGROUND

Generally, riders have a lot of flexibility in setting a pickup location in a ride-sharing transportation service. This may result in a wide variance of quality pickup experiences and is subject to many shortcomings. Typically, recommendations of pickup locations are static and do not consider real-time features. Additionally, conventional systems attempt to set a precise pickup location too early in a user experience, and thus cannot consider features in identifying the optimal pickup point. These conventional systems also focus on the rider experience and do not adequately consider drivers and their experiences. As a result, a rider and driver are oftentimes left to negotiate an actual pickup location either by phone or in real-time as they see each other approach and need to adjust to one another. This can cause anxiety for both parties.

### BRIEF DESCRIPTION OF THE DRAWINGS

Some embodiments are illustrated by way of example and not limitation in the figures of the accompanying drawings.

FIG. 1 is a diagram illustrating a network environment suitable for optimizing a pickup location, according to some example embodiments.

FIG. 2 is a block diagram illustrating components of a network system for optimizing the pickup location, according to some example embodiments.

FIG. 3 is a flowchart illustrating operations of a method for optimizing a pickup location, according to some example embodiments.

FIG. 4 is a flowchart illustrating operations of a method for determining dwell points, according to some example embodiments.

FIG. 5 is a flowchart illustrating operations of a method for determining index scores, according to some example embodiments.

FIG. 6 is a flowchart illustrating operations of a method for determining candidate pickup locations, according to some example embodiments.

FIG. 7 is a block diagram illustrating components of a machine, according to some example embodiments, able to read instructions from a machine-readable medium and perform any one or more of the methodologies discussed herein.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The present disclosure provides technical solutions for optimizing a pickup location by negotiating a suitable pickup location or point for a rider and driver to meet based on a combination of location variables. These location variables may be defined by rider and driver pickup expectations and experiences and be based on historical data of past pickup and drop-off scenarios as well as driver locations of drivers that are “on trip” (e.g., on the way to the pickup location before starting the trip) but within a close proximity to the pickup location.

Pickups are likely the most intractable problem for all ride-sharing companies. Research shows that riders and drivers rely on a ridesharing application during the pickup process as a communication tool to negotiate a suitable rendezvous point almost if not more heavily than as a navigation tool in the last approximately 100 meters. Because riders and drivers put the onus on each other rather than the ridesharing application and network, empathy is lowered between parties from requests to rendezvous leading to cancellations, repetitive contacts, and filed support tickets. More experienced riders may take more care in selecting and communicating their pickup location, increasing the amount of work required of these more committed riders. Many ridesharing applications provide suggestions based on historical data to help users/riders in this task. By negotiating a rendezvous point based on the above requirements, example embodiments create a contextualized, curated experience that minimizes inconvenience for riders, risk for drivers, and wasted time for both parties.

In example embodiments, a network system aggregates trip data received from user devices over time, whereby the trip data includes location information and speed information for a driver. The aggregated trip data also includes historical pickup locations (e.g., selected by riders) and drop-off locations. The network system then analyzes the trip data. Specifically, the network system analyzes the location information and speed associated with past trips to determine dwell points, which are locations where drivers typically stop for at least a predetermined amount of time. It is assumed that these dwell points are theoretically good places to stop regardless of where the requested pickup location is. These dwell points may represent past passenger pickup or drop-off locations, waiting locations, parking locations, or any other location where a driver can safely stop his vehicle for at least the predetermined amount of time. The network system also determines index scores for various locations. These index scores include a prevalence score which is a value that indicates how popular a particular location is (based on selection by users) for pickup and a dwellability score which is a value that indicates how dwellable a particular location is.

During runtime, the network system receives, from a device of a user or rider, a request that includes a requested pickup location. The network system also receives an indication of an actual location of the user (e.g., GPS coordinates). The network system then accesses the index scores associated with the requested pickup location and current location of the user and determines candidate locations where pick up is likely easiest or fastest for both the rider and the driver. As such, example embodiments can provide one or more of the following advantages:
The network system seamlessly incorporates historic and real-time features to provide dynamic pickup point optimization.
The network system provides a holistic framework for enabling riders to walk short distances if they choose to save time while also guiding them to a location that is likely to provide a better pickup experience.
The network system explicitly considers drivers' needs in the optimization (e.g., ease to get to, safe to stop, less likely to receive a ticket for an illegal stop).
The network system prioritizes places where drivers have been able to dwell in the past at that time of day and day of week, which has the potential to reduce congestion and improve adherence to red curbs and bike lanes.
The network system provides a scalable solution to detect where drivers are unable to dwell and down-rank these locations in a pickup point optimization.
The network system considers a broader “pickup zone” around the requested pickup location but also provides a way to identify the best specific candidates within this broader zone.
The network system uses multiple parameters that can either be optimized globally or configured specifically to meet local needs at a city, country, or regional level.
The network system leverages data to improve negotiation of the specific pickup location given particular context, and thus reduces anxiety for both the rider and driver at the time or pickup.

Therefore, example methods (e.g., algorithms) and example systems (e.g., special-purpose machines) are configured to improve a ridesharing process by determining one or more candidate pickup locations that factor in convenience, safety, and time for both riders and drivers. As such, one or more of the methodologies described herein facilitate solving the technical problem of routing vehicles to a pickup location that is safe and convenient for all parties.

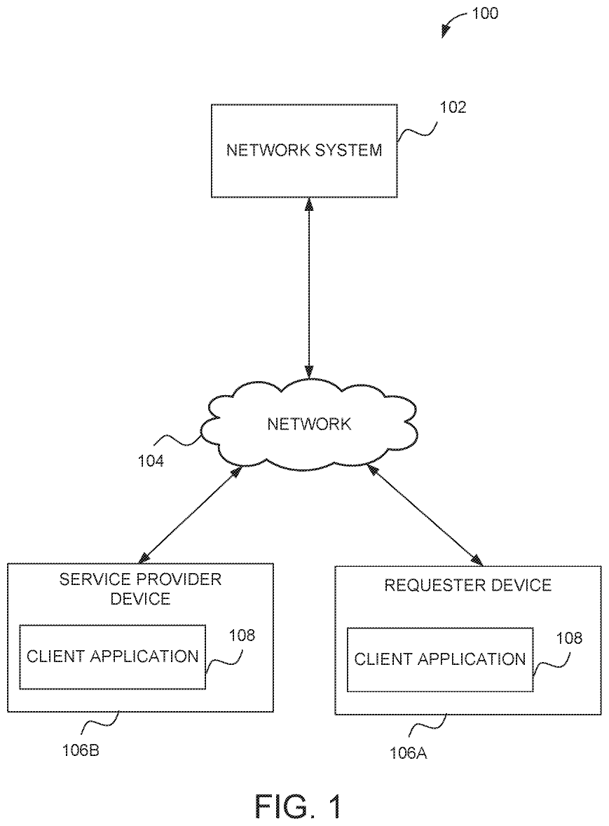

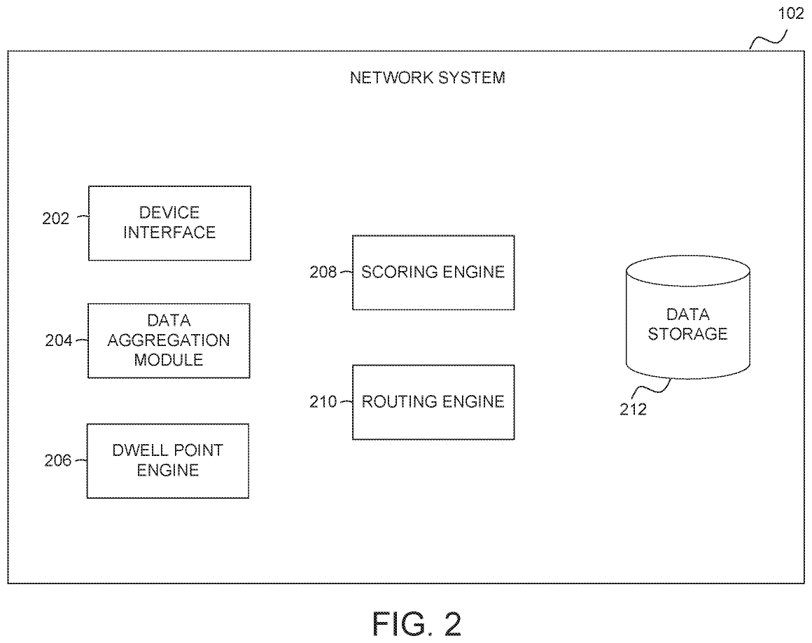

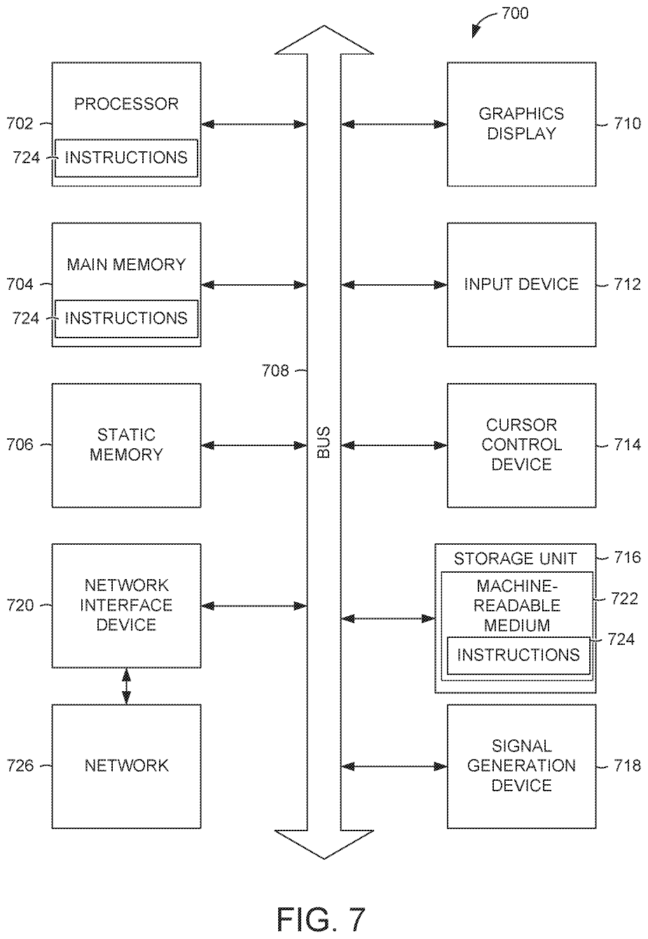

FIG. 1 is a diagram illustrating a network environment 100 suitable for optimizing a pickup location in accordance with example embodiments. The network environment 100 includes a network system 102 communicatively coupled via a network 104 to a requester device 106a of a user or rider and a service provider device 106b of a driver (collectively referred to as “user devices 106”). In example embodiments, the network system 102 comprises components that obtain, store, and analyze trip data received from the user devices 106 in order to negotiate optimal pickup locations. The components of the network system 102 are described in more detail in connection with FIG. 2 and may be implemented in a computer system, as described below with respect to FIG. 7.

The components of FIG. 1 are communicatively coupled via the network 104. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, a satellite network, a cable network, a broadcast network, another type of network, or a combination of two or more such networks. Any one or more portions of the network 104 may communicate information via a transmission or signal medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

In example embodiments, the user devices 106 are portable electronic devices such as smartphones, tablet devices, wearable computing devices (e.g., smartwatches), or similar devices. Alternatively, the service provider device 106b can correspond to an on-board computing system of a vehicle. The user devices 106 each comprises one or more processors, memory, touch screen displays, wireless networking system (e.g., IEEE 802.11), cellular telephony support (e.g., LTE/GSM/UMTS/CDMA/HSDP A), and/or location determination capabilities. The user devices 106 interact with the network system 102 through a client application 108 stored thereon. The client application 108 of the user devices 106 allow for exchange of information with the network system 102 via user interfaces, as well as in background. For example, the client application 108 running on the user devices 106 may determine and/or provide location information of the user devices 106 (e.g., current location in latitude and longitude) and speed to the network system 102, via the network 104, for storage and analysis. In example embodiments, the location and speed information are used by the network system 102 to determine dwell points and typical or popular pickup locations (e.g., also referred to as “hotspots”).

In example embodiments, a first user (e.g., a requester or rider) operates the requester device 106a that executes the client application 108 to communicate with the network system 102 to make a request for a transportation service such as transport or delivery service (referred to collectively as a “trip”). In some embodiments, the client application 108 determines or allows the user to specify/select a pickup location (e.g., of the user or an item to be delivered) and to specify a drop-off location for the trip. The client application 108 also presents information, from the network system 102 via user interfaces, to the user of the requester device 106a. For instance, the user interface can display a request from the network system 102 that indicates more than one candidate pickup locations from which the user can select in order to indicate the location where the user (or item) will be picked up by the driver.

A second user (e.g., a service provider or driver) operates the service provider device 106b to execute the client application 108 that communicates with the network system 102 to exchange information associated with providing transportation service (e.g., to the user of the requester device 106a). The client application 108 presents information via user interfaces to the user of the service provider device 106b, such as invitations to provide the transportation service, navigation instructions, and pickup and drop-off locations of people or items to be transported. The client application 108 also provides data to the network system 102 such as a current location (e.g., coordinates such as latitude and longitude), speed, and/or heading of the service provider device 106b or vehicle.

In example embodiments, any of the systems, machines, databases, or devices (collectively referred to as “components”) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 7, and such a special-purpose computer may be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or devices illustrated in FIG. 1 may be combined into a single system or device, and the functions described herein for any single system or device may be subdivided among multiple systems or devices. Additionally, any number of user devices 106 may be embodied within the network environment 100. Furthermore, some components or functions of the network environment 100 may be combined or located elsewhere in the network environment 100. For example, some of the functions of the networked system 102 may be embodied within other systems or devices of the network environment 100. Additionally, some of the functions of the user device 106 may be embodied within the network system 102. While only a single network system 102 is shown, alternative embodiments may contemplate having more than one network system 102 to perform server operations discussed herein for the network system 102.

FIG. 2 is a block diagram illustrating components of the network system 102, according to some example embodiments. In various embodiments, the network system 102 obtains and stores trip data (e.g., pickup and drop-off locations, route, locations of user devices, speed, data on the way to a pickup location) received from the user devices 106, analyzes the trip data to determine dwell points and hotspots along with their index scores, and uses the analysis to optimize a pickup location by determining one or more candidate pickup locations that may be convenient for both the rider and driver. To enable these operations, the network system 102 comprises a device interface 202, a data aggregation module 204, a dwell point engine 206, a scoring engine 208, a routing engine 210, and a data storage 212 all configured to communicate with each other (e.g., via a bus, shared memory, or a switch). The network system 102 may also comprise other components (not shown) that are not pertinent to example embodiments. Furthermore, any one or more of the components (e.g., engines, interfaces, modules, storage) described herein may be implemented using hardware (e.g., a processor of a machine) or a combination of hardware and software. Moreover, any two or more of these components may be combined into a single component, and the functions described herein for a single component may be subdivided among multiple components.

The device interface 202 is configured to exchange data with the user devices 106 and cause presentation of one or more user interfaces provided by the network system 102 on the user devices 106 including user interfaces to initiate a request for transportation service, select a pickup location from a set of candidate pickup locations, and display a route to the pickup location. The user interface may also display invitations to provide the transportation service on the service provider device 106b, present navigation instructions including maps, and provide notifications.

The data aggregation module 204 is configured to aggregate trip data received from the user devices 106. The trip data can include location information (e.g., latitude and longitude), speed, time for each trip, and cost for the transportation service. The trip data can also include driver locations that are “on trip” (e.g., on the way to the pickup location and before starting a transportation service) but within a close proximity to the pickup location. The trip data is stored to the data storage 212 by the data aggregation module 204.

The dwell point engine 206 is configured to analyze the trip data, and in particular, the location information and speed (e.g., for particular times of the day and/or days of the week) to determine dwell points—locations where drivers typically stop for a predetermined amount of time. Backend processing by the dwell point engine 206 can occur at any time, at predetermined times or intervals (e.g., every night, once a week), when a predetermined amount of trip data has been stored, or based on other factors. in contrast, runtime analysis by the routing engine 206 occurs in real-time in response to a request from a rider for transportation service. Operations of the dwell point engine 206 will be discussed in further detail below.

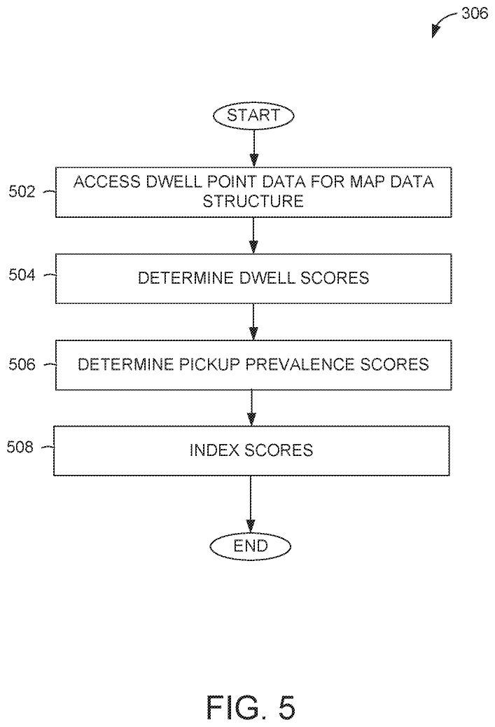

The scoring engine 208 determines dwellability scores (e.g., based on dwell points) and pickup prevalence scores (e.g., based on hotspots) and indexes these scores for later use during runtime by the routing engine 210. The operations of the scoring engine will be discussed in more detail in connection with FIG. 5 below.

The routing engine 210 manages generating and monitoring of routes to a pickup location and between the pickup location and a drop-off location. In particular, the routing engine 210 uses the index scores along with the requested pickup location and actual locations of the rider and driver to determine one or more candidate pickup locations that may be more convenient for both the rider and driver (e.g., less congested stopping location, faster for the driver to get to, safer stopping location). In embodiments where more than one candidate pickup location is determined, a set of candidate pickup locations is presented to the rider (e.g., via the user interface provided through the application 108). The rider can select one of the candidate pickup locations or decide not to select any of the candidate pickup locations (if different from the requested pickup location) and have the pickup location be the requested pickup location initially entered by the rider.

The data storage 212 is configured to store information associated with each user of the network system 102 including trip data and the index scores. The information includes various trip data used by the network system 102 to determine the candidate pickup locations. In some embodiments, the data is stored in or associated with a user profile corresponding to each user and includes a history of interactions using the network system 102. While the data storage 212 is shown to be embodied within the network system 102, alternative embodiments can locate the data storage 212 elsewhere and be communicatively coupled to the network system 102.

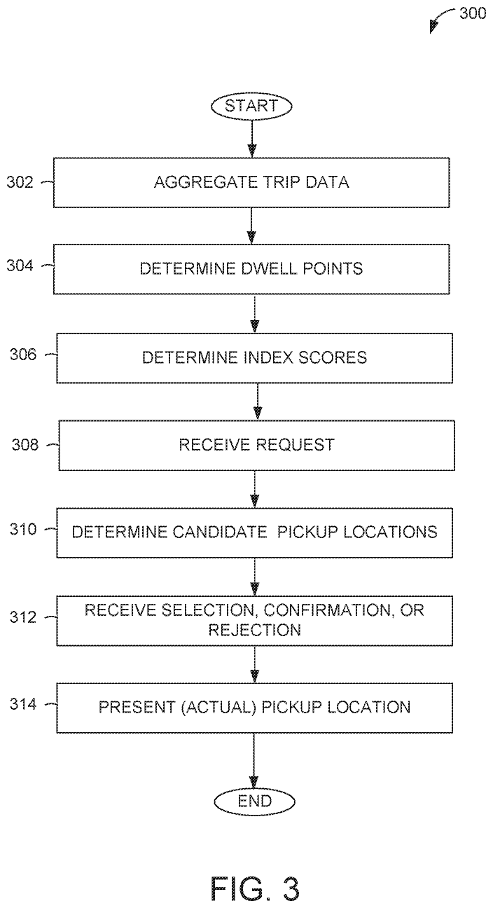

FIG. 3 is a flowchart illustrating operations of a method 300 for optimizing a pickup location, according to some example embodiments. Operations in the method 300 may be performed by the network system 102, using components described above with respect to FIG. 2. Accordingly, the method 300 is described by way of example with reference to the network system 102. However, it shall be appreciated that at least some of the operations of the method 300 may be deployed on various other hardware configurations or be performed by similar components residing elsewhere in the network environment 100. Therefore, the method 300 is not intended to be limited to the network system 102.

In operation 302, the data aggregation module 204 aggregates trip data from a plurality of users. The trip data can include location information (e.g., latitude and longitude), speed, pickup and drop-off locations, times during each trip (e.g., timestamps), and cost for the transportation service. The trip data is stored to the data storage 212 by the data aggregation module 204.

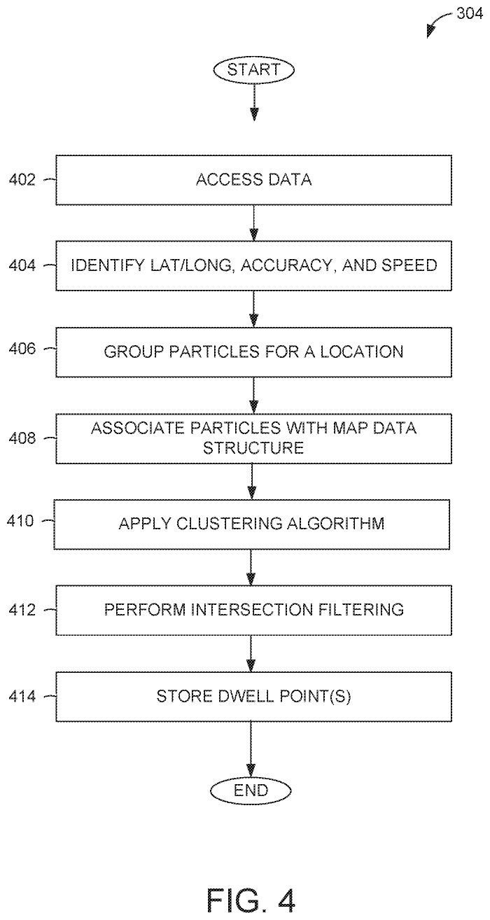

In operation 304, the dwell point engine 206 analyzes the trip data to determine dwell points. Dwell points are locations where drivers typically stop for at least a predetermined amount of time. It is assumed that these dwell points are theoretically good places to stop regardless of where the requested pickup location is. Operation 304 will be discussed in more detail in connection with FIG. 4 below.

In operation 306, the scoring engine 208 determines index scores. The index scores include dwellability scores for the dwell points and pickup prevalence scores for the hotspots or typical pickup locations chosen by riders in the past. Operation 306 will be discussed in more detail in connection with FIG. 5 below.

In example embodiments, operations 302-306 may occur at any time. For example, the aggregation of trip data (operation 302) can take place over a period of time (e.g., a day, a week, a month). Subsequently, the determination of dwell points (operation 304) and determination of index scores (operation 306) can, for example, occur at a predetermined time (e.g., nightly), when a certain amount of trip data has been aggregated, or be triggered manually by an operator of the network system 102.

Operations 308-314 may occur in real-time in response to a trip request. In operation 308, the device interface 202 receives a trip request. In one embodiment, the trip request is for transportation between a pickup location and a drop-off location or destination. In another embodiment, the trip request is for a transportation service that includes picking up an item (e.g., food, cargo) and dropping off the item at a destination (also referred to as the drop-off location). As such, the trip request may include a requested pickup location and a drop-off location.

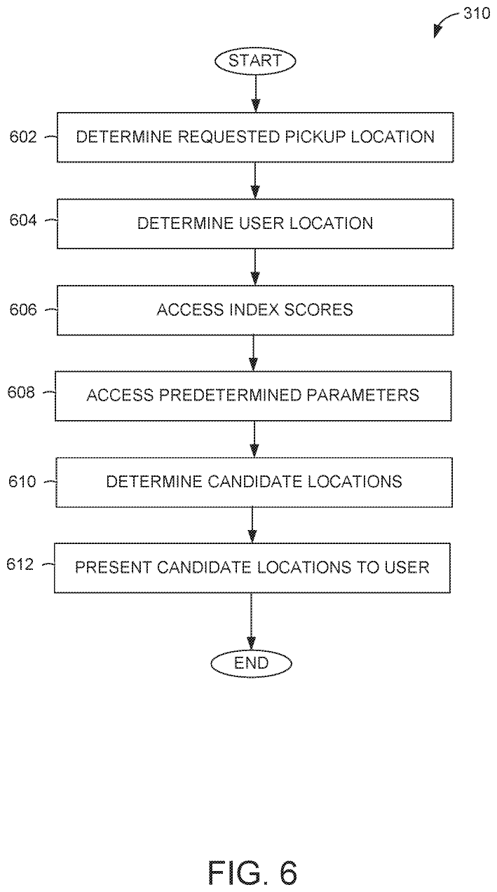

Based on the trip request and the stored data (e.g., index scores, known dwell points, hotspots), candidate pickup locations are determined in operation 310. Operations 310 will be discussed in more detail in connection with FIG. 6 below. Once the candidate pickup locations are determined, the network system 102 causes one or more of the candidate pickup locations to be presented to the rider. The rider, in operation 312, can select one of the candidate pickup locations as the actual pickup location, confirm the candidate pickup location if there is only one candidate pickup location, or reject the candidate pickup location(s) and keep the requested pickup location as the actual pickup location.

Once the selection, confirmation, or rejection is received, the network system 102 causes presentation of the actual pickup location to both the rider and driver on their respective user devices 106 in operation 314. The driver is routed to the (actual) pickup location and, in the cases where the rider selects a candidate pickup location that is not their present location, the rider may be routed (e.g., shown a map and route) to the pickup location as well.

FIG. 4 is a flowchart illustrating operations of a method (operation 304) for determining dwell points, according to some example embodiments, Operations in the method may be performed by the dwell point engine 206. Accordingly, the method is described by way of example with reference to the dwell point engine 206. However, it shall be appreciated that at least some of the operations of the method may be deployed on various other hardware configurations or be performed by similar components residing elsewhere in the network environment 100. Therefore, the method is not intended to be limited to the dwell point engine 206. The operations of the method of FIG. 4 can occur at any time, at predetermined times or intervals (e.g., every night, once a week), when a predetermined amount of trip data has been stored, or based on other factors.

In operation 402, the aggregated trip data is accessed. In example embodiments, the dwell point engine 206 accesses the aggregated trip data from the data storage 212. In some embodiments, the accessed aggregated trip data comprises trip data that was received and stored since a last determination of dwell points was performed.

In operation 404, latitude/longitude data or points, horizontal accuracies, and speeds are identified (e.g., extracted or derived) from the aggregated trip data. In some embodiments, the latitude/longitude data is obtained from GPS data associated with the aggregated trip data. In some cases, the latitude/longitude data represents dwell points of previous drivers as a well as locations that are within a close proximity to pickup points.

A horizontal accuracy is a value that acts as a radius. The horizontal accuracy defines a circle around the latitude/longitude point. The horizontal accuracy is calibrated so that the horizontal accuracy defines a circle in which a true location exists a majority of the time (e.g., 68% of the time). A typical horizontal accuracy may be about 30 meters in one embodiment. A bad horizontal accuracy can be as high as 200-300 meters. A very precise horizontal accuracy can be down to, for example, 1 or 2 meters.

In operation 406, particles are grouped for a (particular) location using the trip data for drivers. A particle comprises a data structure that includes a latitude, a longitude, and a speed. In one embodiment, given a latitude and longitude and a horizontal accuracy, the dwell point engine 206 defines the circle, whereby there is a 68% probability the location is inside the circle and 32% probability is outside the circle. That can be turn into a point cloud (e.g., pulling a plurality of points based on the distribution, most of the points are particles inside the circle). It is noted that alternative embodiments can use other percentages of probability within and outside the circle.

In operation 408, the particles are associated with a map data structure which is a unit on an actual map, In one embodiment, the map data structures are hexagons. However, other shapes or data structures can be used such as rectangles. The dwell point engine 206 initializes P for particles to an empty set. The dwell point engine 206 then goes through each of the locations (l) in a set of location estimates (L). A sampling algorithm is applied for N sample particles. N is a parameter proportional to a Gaussian distribution and equal to a horizontal accuracy. This results in pulling more points close to the latitude/longitude pair and fewer points farther away. The sampling is then performed inversely proportionally to speed and the particles are added into the data structure P. Ideally, the points are locations where drivers are fully stopped (e.g., speed is zero). The particles, P, are then mounted to units on an actual map, thus splitting the map data structures into hexagons.

Within each hexagon, the dwell point engine 206 runs a clustering algorithm. That is, in operation 410, a clustering algorithm is applied within each map data structure. Inside each hexagon is a plurality of particles—mostly clustered where the pickup points are but may be spread out across the hexagon. A spatial clustering technique is then used (e.g., DBScan) that essentially merges the points together and outputs an estimate for each cluster. The estimate indicates one or more points where drivers historically stop or idle while waiting for a rider.

Subsequently, in operation 412, intersection filtering is performed. In example embodiments, the intersection filtering comprises filtering out intersections that are stop signs or stop lights near (e.g., within a threshold distance of) pickup locations. The remaining dwell points are stored to the data storage 212 in operation 414,

In one embodiment, the method of FIG. 4 occurs as follows.

### Probabilistic Dwell Point Generation

Require: L: Set of GPS location estimates comprising coordinate pairs, horizontal accuracy estimates, and speed estimates from a sequence of driver GPS estimates
Require: Spatio-temporal Discretization Function
Require: Spatial Clustering Algorithm
Optional: I: Set of intersections of the local road network
   P←{} (Initialize particles to an empty set)
   for l in L:
      s←sample(l) Sample n particles proportional to a 2-dimensional Gaussian distribution with mean equal to the location's latitude and longitude and standard deviation equal to 1.horizontal_accuracy
      s←sample(s) Sample particles inversely proportionally to s.speed
      P←s Add particles to P
   D←Discretize(P) Map each particle to a spatio-temporal discretization
   C←{} (Initialize clusters to an empty set)
   for d in D:
      C←Cluster(d) Perform spatial clustering algorithm of choice within each discretization
   C←intersectionFilter(C) (Optional) Perform geospatial join and filter clusters within given distance of known intersections I
   return C

Potential clustering algorithms include, for example, K-Means, Mean-Shift Clustering, Expectation-Maximization Clustering using Gaussian Mixture Models, Agglomerative Hierarchical Clustering, DBScan, and HDBScan. Spatial discretization methods can include, for example, Uber's H2, Google's S2, and Geohash.

FIG. 5 is a flowchart illustrating operations of a method (operation 306) for determining index scores, according to some example embodiments. Operations in the method may be performed by the scoring engine 208. Accordingly, the method is described by way of example with reference to the scoring engine 208. However, it shall be appreciated that at least some of the operations of the method may be deployed on various other hardware configurations or be performed by similar components residing elsewhere in the network environment 100. Therefore, the method is not intended to be limited to the scoring engine 208. The operations of the method of FIG. 5 can occur at any time, at predetermined times or intervals, or based on other factors.

In operation 502, dwell point data for map data structures are accessed. In example embodiments, the dwell point data is accessed from the data storage 212, where the dwell point data was stored after operation 304. Hotspot data may also be accessed in operation 502.

In operation 504, the scoring engine 208 determines dwell scores (Dwellability) and in operation 506, the scoring engine 208 determines pickup prevalence scores (PickupPrevalence). The scores are indexed (e.g., in the data storage 212) in operation 508. In one embodiment, the method of FIG. 5 occurs as follows.

### Hierarchically-Normalized Cross-Ranking for Online Optimization

Pre-Computation
Require: Coarse-grained spatial discretization function
Require: Fine-grained spatial discretization function
Require: Pickups: Set of driver GPS location estimates comprising coordinate pairs, horizontal accuracy estimates, and speed estimates from a sequence of driver GPS estimates at the time trips begin
Require: L: Set of GPS location estimates comprising coordinate pairs, horizontal accuracy estimates, and speed estimates from a sequence of driver GPS estimates before the trip begins
DP←Initialize dwell to a set of previously-generated dwell points
H←Initialize hotspots to a set of previously-generated points
FDHS←Initialize map from fine-grained discretization to count of hotspot particles
CDHS←Initialize map from coarse-grained discretization to count of hotspot particles
discretizationMap←Initialize map from fine-grained discretization to coarse-grained discretization
for pickup in Pickups:
   s←sample(pickup) Sample n particles proportionalto a 2-dimensional Gaussian distribution with mean equal to the location's latitude and longitude and standard deviation equal to 1.horizontal_accuracy
   Particles←sample(s) Sample particles inversely proportionally to s.speed
FDHS←GroupBy(fine-grained discretization).count(particles)
CDHS←GroupBy(coarse-grained discretization).count(particles)
FDDP←Initialize map, from fine-grained discretization to count of dwell point particles
CDDP←Initialize map from coarse-grained discretization to count of dwell point particles
for l in L:
   s←sample(l) Sample n particles proportional to a 2-dimensional Gaussian distribution with mean equal to the location's latitude and longitude and standard deviation equal to 1.horizontal_accuracy
   Particles←sample(s) Sample particles inversely proportionally to s.speed
for p in Particles:
FDDP←GroupBy(fine-grained discretization).count(particles)
CDDP←GroupBy(coarse-grained discretization).count(particles)
PickupPrevalence←Initialize map from hotspot to pickup prevalence
Dwellability←Initialize map from dwell point to dwellability score for hs in HS:
   PickupPrevalence[hs]←FDHS[FD[hs]]/CDHS[CD[hs]] for dp in DP:
   Dwellability[dp]←FDDP[FD[dp]]/CDDP[CD[dp]]
return PickupPrevalence, Dwellability

FIG. 6 is a flowchart illustrating operations of a method (operation 310) for determining candidate pickup location(s), according to some example embodiments. Operations in the method may be performed by the routing engine 210. Accordingly, the method is described by way of example with reference to the routing engine 210. However, it shall be appreciated that at least some of the operations of the method may be deployed on various other hardware configurations or be performed by similar components residing elsewhere in the network environment 100. Therefore, the method is not intended to be limited to the routing engine 210. The operations of the method of FIG. 6 occur during runtime in response to receiving a trip request from a user (e.g., rider, food delivery service requester) for transportation service.

In operation 602, the routing engine 210 analyzes the trip request to determine a requested pickup location. The requested pickup location is the pickup location indicated by e rider and may correspond to the rider's current location or a nearby location.

In operation 604, the routing engine 210 determines the rider's actual location. The actual location may be determined from GPS data associated with the requester device 106a. The actual location may be different from the requested pickup location. If it is not different, operation 604 can be skipped in some embodiments.

In operation 606, the routing engine 210 accesses the index scores for one or more dwell points and/or hotspots associated with the actual location. The index scores include dwellability scores and pickup prevalence scores generated by the scoring engine 208 as discussed above.

The routing engine 210 also accesses predetermined parameters in operation 608. The predetermined parameters comprise various weights and distances (e.g., maximum distance from requested pickup location to consider candidate pickup locations). The predetermined parameters may be default parameters established by the network system 102 or be customized to each user based on user preferences. For example, a predetermined parameter may limit a candidate pickup location to be within 100 meters of the requested pickup location.

Using the accessed index scores and predetermined parameters, the routing engine 210 determines one or more candidate pickup locations in operation 610. The candidate pickup locations may be ranked and a top number of candidate pickup locations selected for presentation to the rider/requester (e.g., on a map displayed on the requester device 106a).

The top candidate pickup location(s) are presented to the user/rider in operation 612. In example embodiments, a reason may be presented with each candidate pickup location. For example, a first candidate pickup location may be easier for the driver to get to, which results in a faster pickup time. In another example, a second candidate pickup location may be around the corner from the requested pickup location because it will be less congested and a safer location for the driver to stop at and easier for the rider to find the driver and get into the vehicle. In a third example, the third candidate pickup location may be 50 meters down the street from the requested pickup location in order to avoid a bus zone.

In one embodiment, the method of FIG. 6 occurs as follows. Some of the parameters (e.g., weights, distances, numbers) may be default to the network system 102 or be based on user preferences,

Runtime Scoring
Require: requestedPickupLocation: Requested pickup location around which to consider optimal pickup locations.
Require: maxDistance: Maximum distance to consider pickup points from the requested pickup point (e.g., a predetermined parameter),
Require: dwell Weight: Ratio of importance to assign to the dwellability of a particular point. Weight to assign to dwell score in ranking. This may be a second predetermined parameter.
Require: pickupPointProximityWeight: Ratio of importance to assign to the distance from the point to requestedPickupLocation. Weight to assign to proximity between the map data structure and the requested pickup location in ranking (e.g., a third predetermined parameter).
Require: pickupPrevalenceWeight: Ratio of importance to assign to the relative frequency. Weight to assign to pickup prevalence score in ranking.
Require: userLocation: Last known user location.
Require: userProximityWeight: Weight to assign to proximity between the map data. structure and the last known user location in ranking.
Require: deduplicationMinDistance: Minimum distance that must exist between two points to show both to the user, The point with the higher score will be shown.
Require: numCandidates: Maximum number of candidate locations to surface to the user
Require: pickupPrevalence: Score for pickup prevalence (e.g., prevalence score)
Require: dwellability: Score for dwellability (e.g., dwellability score)
   DP Candidates←Initialize list of candidates to previously-generated dwell-point candidates within maxDistance of the requestedPickupLocation
   HSCandidates←Initialize list of candidates to previously-generated hotspot candidates within maxDistance of the requestedPickupLocation
   scores←Initialize to map from point to score
   for dp in DP:
      normalizedPickupPointDistance=(maxDistance−distance(requestedPickupLocation, dp))/maxDistance
      pickupPointProximityScore=pickupPointProximityWeight* normalizedPickupPointDistance
      normalizedUserDistance=(maxDistance−distance(userLocation, dp))/maxDistance
      userProximityScore=userProximityWeight*normalizedUserDistance
      pickupPrevalenceScore=pickupPrevalence[hs]*pickupPrevalenceWeight
      score[hs]=pickupPrevalenceScore+requestedPointProximityScore+userProximityScore
   for hs in HS:
      normalizedPickupPointDistance=(maxDistance−distance(requestedPickupLocation, hs))/maxDistance
      pickupPointProximityScore=pickupPointProximityWeight*normalizedDistance
      normalizedUserDistance=(maxDistance−distance(userLocation, hs))/maxDistance
      userProximityScore=userProximityWeight*normalizedUserDistance
      dwellabilityScore=Dwellability[hs]*dwellWeight
      score[dp]=dwellabilityScore+requestedPointProximityScore+userProximityScore
   unifiedCandidate←union(DPCandidates+HSCandidates)
   unifiedCandidates←sorted(unifiedCandidates, key=score)
   for c1 in unifiedCandidates:
      for c2 in unifiedCandidates:
         if distance(c1, c2)<deduplicationMinDistance & c1 !=c2:
      remove c2 from unifiedCandidates
   finalCandidates=unifiedCandidates.limitTo(numCandidates)
   return finalCandidates

The following provides use cases for example embodiments. Initially, a rider sets the destination. During a pickup setting/refinement phase, the network system 102 presents candidate pickup locations which may comprise a combination of hotspots and dwell points with dwell points taking priority based on distance from the requested pickup location. The rider then selects an actual pickup location. In a next phase, a driver accepts the transportation request and proceeds to the actual pickup location. The trip begins when the rider enters the vehicle of the driver.

Example embodiments provide additional experiences. These take into consideration rider key concerns, such as, safety, efficiency, convenience, and driver experience, as well as, driver key concerns including safety, traffic impact, tickets, and ratings.

In one use case, the driver is sent to a hotspot, an area where riders often request pickup from. At this hotspot, the driver may get a ticket for pulling into a bus stop. Example embodiments may adjust the pickup location to a certain distance (e.g., 40 meters) away where drivers sent to that area (e.g., block or street) in the past typically pull into to wait. The network system 102 can assume that the location drivers typically wait at is a better pickup option.

In another user case, riders often set their pickup location to a location directly outside of a business (e.g., movie theatre). Drivers do not to like to stop at this location because the request density is high (e.g., multiple requesters at the same location) and it may be difficult to find the rider. Estimated times of arrival (ETAs) are shorter, contacts and cancellations are less at pickup locations around the corner, or drivers often pull around the corner to wait. In some embodiments, the network system 102 determines the better pickup location on behalf of the rider (e.g., around the corner) rather than putting users into a challenging rendezvous situation.

In a further use case, riders getting picked up on a certain side of a busy intersection often have to cross the street, face high ETAs, or work out where to go for the most efficient pickup. Instead, the network system 102 may provide a pickup location recommendation (e.g., candidate pickup location) that mitigates the driver's need to go through the intersection, speeding up the ETA and potentially avoiding unnecessary re-routing (e.g. going around the block).

In another use case, riders set their pickup location on the inside or just outside of sprawling markets in places like the capital of Mexico City or Mumbai. Drivers cannot get inside the markets and it is hard for the drivers to even get near the edges of the market in a timely manner. This often results in a series of contacts, walking, re-routing, and sometimes cancellations. The network system 102 can suggest a candidate pickup location within a reasonable distance of the rider's location or requested pickup location and away from the market.

For a use case involving shared or pool transportation services, conventionally, a system generates pickup locations at corners to optimize dispatch. A drawback to this approach is that street corners do not tend to make good pickup locations, forcing drivers to either block crosswalks and traffic or negotiate another pickup location with the rider at the time of arrival. The network system 102, instead, identifies points where drivers tend to idle, which are likely to be safer, quieter points off to the sides of street and away from busy intersections. Leveraging dwell points as candidate pickup locations can reduce driver anxiety, vehicular congestion, and improve rider safety.

FIG. 7 illustrates components of a machine 700, according to some example embodiments, that is able to read instructions from a machine-storage medium (e.g., a machine-readable storage device, a non-transitory machine-readable storage medium, a computer-readable storage medium, or any suitable combination thereof) and perform any one or more of the methodologies discussed herein. Specifically, FIG. 7 shows a diagrammatic representation of the machine 700 in the example form of a computer device (e.g., a computer) and within which instructions 724 (e.g., software, a program, an application, an applet, an app, or other executable code) for causing the machine 700 to perform any one or more of the methodologies discussed herein may be executed, in whole or in part.

For example, the instructions 724 may cause the machine 700 to execute the flow diagrams of FIGS. 3-6. In one embodiment, the instructions 724 can transform the general, non-programmed machine 700 into a particular machine (e.g., specially configured machine) programmed to carry out the described and illustrated functions in the manner described.

In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724 (sequentially or otherwise) that specify actions to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a graphics display 710 (e.g., a plasma display panel (PDP), a light emitting diode (LEI)) display, a liquid crystal display (LCD), a projector, or a cathode ray tube (CRT), or any other display capable of displaying graphics or video). The machine 700 may also include an input device 712 (e.g., a keyboard), a cursor control device 714 (e.g., a mouse, a touchpad, a trackball, a joystick, a motion sensor, or other pointing instrument), a storage unit 716, a signal generation device 718 (e.g., a sound card, an amplifier, a speaker, a headphone jack, or any suitable combination thereof), and a network interface device 720.

The storage unit 716 includes a machine-storage medium 722 (e.g., a tangible machine-readable storage medium) on which is stored the instructions 724 (e.g., software) embodying any one or more of the methodologies or functions described herein. The instructions 724 may also reside, completely or at least partially, within the main memory 704, within the processor 702 (e.g., within the processor's cache memory), or both, before or during execution thereof by the machine 700, Accordingly, the main memory 704 and the processor 702 may be considered as machine-readable media (e.g., tangible and non-transitory machine-readable media). The instructions 724 may be transmitted or received over a network 726 via the network interface device 720.

In some example embodiments, the machine 700 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable in and Machine-Storage Medium

The various memories (i.e., 704, 706, and/or memory of the processor(s) 702) and/or storage unit 716 may store one or more sets of instructions and data structures (e.g., software) 724 embodying or utilized by any one or more of the methodologies or functions described herein. These instructions, when executed by processor(s) 702 cause various operations to implement the disclosed embodiments.

As used herein, the terms “machine-storage medium,” “device-storage medium,” “computer-storage medium” (referred to collectively as “machine-storage medium 722”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 722 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media 722 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 724 may further be transmitted or received over a communications network 726 using a transmission medium via the network interface device 720 and utilizing any one of a number of well-known transfer protocols (e.g., HTTP). Examples of communication networks 726 include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 724 for execution by the machine 700, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-storage medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

### EXAMPLES

Example 1 is a method for optimizing a pickup location. The method comprises receiving, by a network system, a request for transportation service from a device of a rider, the request including a requested pickup location; based on the requested pickup location, determining, by one or more hardware processors of the network system, one or more candidate pickup locations that optimize for a pickup location, the determining the one or more candidate pickup locations comprising determining an actual location of the rider; accessing index scores associated with the actual location; identifying dwell point and hotspot candidates based on corresponding index scores; and selecting one or more dwell point and hotspot candidates as the one or more candidate pickup locations; and causing presentation of the one or more candidate pickup locations on a user interface on the device of the rider.

In example 2, the subject matter of example I can optionally include wherein the selecting one or more dwell point or hotspot candidates comprises accessing predetermined parameters including weights and distances; applying the predetermined parameters to the index scores; and ranking a result of the applying, the one or more dwell point or hotspot candidates being a top number of the one or more dwell point or hotspot candidates based on the ranking.

In example 3, the subject matter of any of examples 1-2 can optionally include wherein the index scores associated with the actual location comprises a dwellability score for each dwell point associated with the actual location and a prevalence score for each hotspot associated with the actual location.

In example 4, the subject matter of any of examples 1-3 can optionally include aggregating, by the network system, trip data; using the trip data, determining dwell points, the dwell points being locations where drivers typically stop for at least a predetermined amount of time; and using the trip data, determining hotspots, the hotspots being popular pickup locations used in the past.

In example 5, the subject matter of any of examples 1-4 can optionally include determining the index scores, the index scores including a dwellability score for each dwell point and a prevalence score for each hotspot.

In example 6, the subject matter of any of examples 1-5 can optionally include identifying a latitude and a longitude, a horizontal accuracy, and a speed for each trip in the trip data; grouping particles for a location, each particle being a data structure that includes the latitude, the longitude, and the speed; associating the particles with a map data structure; applying a clustering algorithm to the map data structure; and performing intersection filtering to remove intersections.

In example 7, the subject matter of any of examples 1-6 can optionally include receiving a selection or confirmation of a candidate pickup location from the one or more candidate pickup; and responsive to the selection or confirmation, causing presentation of the candidate pickup location as an actual pickup location to the rider and a driver providing the transportation service.

In example 8, the subject matter of any of examples 1-7 can optionally include receiving a rejection of the one or more candidate pickup locations; and responsive to the rejection, causing presentation of the requested pickup location as an actual pickup location to the rider and a driver providing the transportation service.

Example 9 is a system for optimizing a pickup location. The system includes one or more processors and a memory storing instructions that, when executed by the one or more hardware processors, causes the one or more hardware processors to perform operations comprising receiving a request for transportation service from a device of a rider, the request including a requested pickup location; based on the requested pickup location, determining one or more candidate pickup locations that optimize for a pickup location, the determining the one or more candidate pickup locations comprising determining an actual location of the rider; accessing index scores associated with the actual location; identifying dwell point and hotspot candidates based on corresponding index scores; and selecting one or more dwell point and hotspot candidates as the one or more candidate pickup locations; and causing presentation of the one or more candidate pickup locations on a user interface on the device of the rider.

In example 10, the subject matter of example 9 can optionally include wherein the selecting one or more dwell point or hotspot candidates comprises accessing predetermined parameters including weights and distances; applying the predetermined parameters to the index scores; and ranking a result of the applying, the one or more dwell point or hotspot candidates being a top number of the one or more dwell point or hotspot candidates based on the ranking.

In example 11, the subject matter of any of examples 9-10 can optionally include wherein the index scores associated with the actual location comprises a dwellability score for each dwell point associated with the actual location and a prevalence score for each hotspot associated with the actual location.

In example 12, the subject matter of any of examples 9-11 can optionally include aggregating, by the network system, trip data; using the trip data, determining dwell points, the dwell points being locations where drivers typically stop for at least a predetermined amount of time; and using the trip data, determining hotspots, the hotspots being popular pickup locations used in the past.

In example 13, the subject matter of any of examples 9-12 can optionally include determining the index scores, the index scores including a dwellability score for each dwell point and a prevalence score for each hotspot.

In example 14, the subject matter of any of examples 9-13 can optionally include identifying a latitude and a longitude, a horizontal accuracy, and a speed for each trip in the trip data; grouping particles for a location, each particle being a data structure that includes the latitude, the longitude, and the speed; associating the particles with a map data structure; applying a clustering algorithm to the map data structure; and performing intersection filtering to remove intersections.

In example 15, the subject matter of any of examples 9-14 can optionally include receiving a selection or confirmation of a candidate pickup location from the one or more candidate pickup; and responsive to the selection or confirmation, causing presentation of the candidate pickup location as an actual pickup location to the rider and a driver providing the transportation service.

In example 16, the subject matter of any of examples 9-15 can optionally include receiving a rejection of the one or more candidate pickup locations; and responsive to the rejection, causing presentation of the requested pickup location as an actual pickup location to the rider and a driver providing the transportation service.

Example 17 is a machine-storage medium storing instructions for optimizing a pickup location. The machine-storage medium configures one or more processors to perform operations comprising receiving a request for transportation service from a device of a rider, the request including a requested pickup location; based on the requested pickup location, determining one or more candidate pickup locations that optimize for a pickup location, the determining the one or more candidate pickup locations comprising determining an actual location of the rider; accessing index scores associated with the actual location; identifying dwell point and hotspot candidates based on corresponding index scores; and selecting one or more dwell point and hotspot candidates as the one or more candidate pickup locations; and causing presentation of the one or more candidate pickup locations on a user interface on the device of the rider.

In example 18, the subject matter of example 17 can optionally include wherein the selecting one or more dwell point or hotspot candidates comprises accessing predetermined parameters including weights and distances; applying the predetermined parameters to the index scores; and ranking a result of the applying, the one or more dwell point or hotspot candidates being a top number of the one or more dwell point or hotspot candidates based on the ranking.

In example 19, the subject matter of any of examples 17-18 can optionally include wherein the index scores associated with the actual location comprises a dwellability score for each dwell point associated with the actual location and a prevalence score for each hotspot associated with the actual location.

In example 20, the subject matter of any of examples 17-19 can optionally include aggregating, by the network system, trip data; using the trip data, determining dwell points, the dwell points being locations where drivers typically stop for at least a predetermined amount of time; using the trip data, determining hotspots, the hotspots being popular pickup locations used in the past; and determining the index scores, the index scores including a dwellability score for each dwell point and a prevalence score for each hotspot.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters.” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. in general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
receiving, by a network system, a request for transportation service from a device of a rider, the request including a requested pickup location;
based on the requested pickup location, determining, by one or more hardware processors of the network system, one or more candidate pickup locations that optimize for a pickup location, the determining the one or more candidate pickup locations comprising
determining an actual location of the rider;
accessing index scores associated with the actual location;
identifying dwell point and hotspot candidates based on corresponding index scores; and
selecting one or more dwell point and hotspot candidates as the one or more candidate pickup locations; and
causing presentation of the one or more candidate pickup locations on a user interface on the device of the rider.

2. The method of claim 1, wherein the selecting one or more dwell point or hotspot candidates comprises:
accessing predetermined parameters including weights and distances;
applying the predetermined parameters to the index scores; and
ranking a result of the applying, the one or more dwell point or hotspot candidates being a top number of the one or more dwell point or hotspot candidates based on the ranking.

3. The method of claim 1, wherein the index scores associated with the actual location comprises a dwellability score for each dwell point associated with the actual location and a prevalence score for each hotspot associated with the actual location.

4. The method of claim 1, further comprising:
aggregating, by the network system, trip data;
using the trip data, determining dwell points, the dwell points being locations where drivers typically stop for at least a predetermined amount of time; and
using the trip data, determining hotspots, the hotspots being popular pickup locations used in the past.

5. The method of claim 4, further comprising:
determining the index scores, the index scores including a dwellability score for each dwell point and a prevalence score for each hotspot.

6. The method of claim 4, wherein the determining the dwell points comprises:
identifying a latitude and a longitude, a horizontal accuracy, and a speed for each trip in the trip data;
grouping particles for a location, each particle being a data structure that includes the latitude, the longitude, and the speed;
associating the particles with a map data structure;
applying a clustering algorithm to the map data structure; and
performing intersection filtering to remove intersections.

7. The method of claim 1, further comprising:
receiving a selection or confirmation of a candidate pickup location from the one or more candidate pickup; and
responsive to the selection or confirmation, causing presentation of the candidate pickup location as an actual pickup location to the rider and a driver providing the transportation service.

8. The method of claim 1, further comprising:
receiving a rejection of the one or more candidate pickup locations; and
responsive to the rejection, causing presentation of the requested pickup location as an actual pickup location to the rider and a driver providing the transportation service.

9. A system comprising:
one or more hardware processors; and
memory storing instructions that, when executed by the one or more hardware processors, cause the one or more hardware processors perform operations comprising:
receiving a request for transportation service from a device of a rider, the request including a requested pickup location;
based on the requested pickup location, determining one or more candidate pickup locations that optimize for a pickup location, the determining the one or more candidate pickup locations comprising
determining an actual location of the rider;
accessing index scores associated with the actual location;
identifying dwell point and hotspot candidates based on corresponding index scores; and
selecting one or more dwell point and hotspot candidates as the one or more candidate pickup locations; and
causing presentation of the one or more candidate pickup locations on a user interface on the device of the rider.

10. The system of claim 9, wherein the selecting one or more dwell point or hotspot candidates comprises:
accessing predetermined parameters including weights and distances;
applying the predetermined parameters to the index scores; and
ranking a result of the applying, the one or more dwell point or hotspot candidates being a top number of the one or more dwell point or hotspot candidates based on the ranking.

11. The system of claim 9, wherein the index scores associated with the actual location comprises a dwellability score for each dwell point associated with the actual location and a prevalence score for each hotspot associated with the actual location.

12. The system of claim 9, wherein the operations further comprise:
aggregating, by the network system, trip data;
using the trip data, determining dwell points, the dwell points being locations where drivers typically stop for at least a predetermined amount of time; and
using the trip data, determining hotspots, the hotspots being popular pickup locations used in the past.

13. The system of claim 12, wherein the operations further comprise:
determining the index scores, the index scores including a dwellability score for each dwell point and a prevalence score for each hotspot.

14. The system of claim 12, wherein the determining the dwell points comprises:
identifying a latitude and a longitude, a horizontal accuracy, and a speed for each trip in the trip data;
grouping particles for a location, each particle being a data structure that includes the latitude, the longitude, and the speed;
associating the particles with a map data structure;
applying a clustering algorithm to the map data structure; and
performing intersection filtering to remove intersections.

15. The system of claim 9, wherein the operations further comprise:
receiving a selection or confirmation of a candidate pickup location from the one or more candidate pickup; and
responsive to the selection or confirmation, causing presentation of the candidate pickup location as an actual pickup location to the rider and a driver providing the transportation service.

16. The system of claim 9, wherein the operations further comprise:
receiving a rejection of the one or more candidate pickup locations; and
responsive to the rejection, causing presentation of the requested pickup location as an actual pickup location to the rider and a driver providing the transportation service.

17. A machine-storage medium storing instructions that, when executed by one or more hardware processors of a machine, cause the machine to perform operations comprising:
receiving a request for transportation service from a device of a rider, the request including a requested pickup location;
based on the requested pickup location, determining one or more candidate pickup locations that optimize for a pickup location, the determining the one or more candidate pickup locations comprising
determining an actual location of the rider;
accessing index scores associated with the actual location;
identifying dwell point and hotspot candidates based on corresponding index scores; and
selecting one or more dwell point and hotspot candidates as the one or more candidate pickup locations; and
causing presentation of the one or more candidate pickup locations on a user interface on the device of the rider.

18. The machine-storage medium of claim 17, wherein the selecting one or more dwell point or hotspot candidates comprises:
accessing predetermined parameters including weights and distances;
applying the predetermined parameters to the index scores;
ranking a result of the applying, the one or more dwell point or hotspot candidates being a top number of the one or more dwell point or hotspot candidates based on the ranking.

19. The machine-storage medium of claim 17, wherein the index scores associated with the actual location comprises a dwellability score for each dwell point associated with the actual location and a prevalence score for each hotspot associated with the actual location.

20. The machine-storage medium of claim 17, wherein the operations further comprise:
aggregating, by the network system, trip data;
using the trip data, determining dwell points, the dwell points being locations where drivers typically stop for at least a predetermined amount of time;
using the trip data, determining hotspots, the hotspots being popular pickup locations used in the past; and
determining the index scores, the index scores including a dwellability score for each dwell point and a prevalence score for each hotspot.
